(19) United States
(12) Patent Application Publication
(10) Pub. No.: US 2007/0181605 A1
(43) Pub. Date: Aug. 9, 2007

(54) Fluid dispenser for minimizing residual fluid content

(76) Inventor: David Ue-Ming Yang, Moraga, CA (US)

Correspondence Address: DAVID UE-MING YANG, 1020 WICKHAM DR., MORAGA, CA, 94556, US

(21) Appl. No.: 11/347,755

(22) Filed: Feb. 6, 2006

(51) Int. Cl. B65D 88/54; B67D 5/60

(52) U.S. Cl. 222/321.5; 222/464.7

(57) ABSTRACT

A self-standing fluid dispenser has a main hollow body, and a second hollow body integrally connected to the bottom of main hollow body to form a sump. A pumping device draws fluid content out of dispenser through the bottom entrance of a down comer tube located within the sump. The fluid dispenser stably stands on support legs that have a height no less than the height of the sump. The fluid dispenser is capable of emptying the fluid content in the main hollow body completely. The residual fluid content remained in the dispenser is reduced to about the interior volume of the sump.

### BACKGROUND OF THE INVENTION

The present invention relates to a self-standing fluid dispenser that has a pump actuator and a discharge spout located at the top of dispenser.

Many fluid products such as liquid soap, shampoo, lotion, . . . etc. are commercially packaged in a disposable, self-standing dispenser with a pump actuator and a discharge spout located at the top of dispenser. The pump actuator draws the fluid product upward through a down comer tube. It is well known that such a conventional fluid dispenser suffers a drawback of inability for emptying the fluid product completely. This is because the pump actuator ceases to draw the fluid content as soon as the bottom entrance of the down comer tube being uncovered. As a result, there is a small amount of residual fluid product remained and wasted in the dispenser.

The amount of wasted residual fluid product is determined by the cross sectional area at the base of the dispenser, and the distance of clearance between the bottom entrance of the down comer tube and the base of the dispenser. One common approach in prior art to reduce the residual fluid product is to provide a step-down, reduced-cross sectional area at the base of dispenser. Such prior approach does not solve the problem satisfactorily. This is because the reduction in the cross sectional area at the base can adversely affect the stability of the dispenser standing in an up-right position.

Another approach in prior art can be found in U.S. Pat. No. 5,366,119, which discloses a dispenser bottle having a sloped internal base, a recessed sump and a flat exterior base. The sloped internal base slopes inwardly to terminate in the recessed sump so that the bottom of draw tube (i.e., down comer tube) fits snugly into the sump. The bottom of the draw tube has a plurality of vertically extending slots so that fluid content can be drained into the sump. Such a dispenser bottle of U.S. Pat. No. 5,366,119 has several drawbacks.

First, the overall height of dispenser bottle increases significantly. This is due to overlapping the sloped internal and the flat exterior bases, and adding the heights of both the sloped internal base and the sump. Second, the material, manufacturing, packing and transportation costs of the dispenser increase significantly due to overlapping the sloped internal base and the flat exterior base. There is also a technical problem in the dispenser bottle of U.S. Pat. No. 5,366,119. This is because the fluid content can only be drained into the sump through vertically extending slots at the bottom of the draw tube. Such a narrow and tortured flow path can adversely defeat the pumping ability of the dispenser.

It is understood that the issue of wasted residual fluid content needs to be concerned because the fluid dispenser is disposed (rather than being refilled and reused) after its usage. A disposable fluid dispenser is commercially marketable only if it has reasonably low packaging, transportation, material and manufacturing costs.

The fluid dispenser of present invention incorporates a sump integrated to a flat base that is raised up by external support legs. The bottom entrance of down comer tube is located in the sump at a level below the base of the dispenser. The sump provides sufficient clearance around the bottom entrance of down comer tube so that the pumping ability of dispenser is not affected. The support legs not only allow the dispenser to stably stand in right-up position, but also raise the flat base to a height so that the sump at the same height can be integrally connected to the flat base from below. Based on the principal of fluid hydraulic, the pump actuator continues to draw fluid content out of dispenser as long as the bottom entrance of down comer tube is submerged by fluid content. As long as the pump continues to draw the fluid content out of dispenser, the level of the fluid content continues to drop while the fluid content continues to drain into the sump by gravity, regardless the base of dispenser being flat or being sloped. Accordingly, the fluid dispenser of present invention eliminates the need for the sloped internal base, and the need for the redundant sloped internal base and flat exterior base. According to present invention, the residual fluid content is reduced to about the interior volume of the sump, and the material, manufacturing, packaging and transportation costs of dispenser are reduced to the lowest level.

### SUMMARY OF THE INVENTION

An object of present invention is to provide a fluid dispenser for mining the wasted residual fluid content.

Another object of present invention is to provide a commercially marketable, disposable fluid dispenser at the lowest material, manufacturing, packaging and transportation costs.

### BRIEF DESCRIPTION OF THE DRAWINGS

FIG. 1 is a perspective view of the first preferred embodiments of the fluid dispenser of the invention in an up-right position.

FIG. 2 is a perspective view of the first preferred embodiments of the fluid dispenser of the invention rotated 90 degree form the up-right position.

FIG. 3 is a cross sectional view A-A of FIG. 1 and FIG. 2.

FIG. 4 is a perspective view of the second preferred embodiments of the fluid dispenser of the invention in an up-right position.

FIG. 5 is a perspective view of the second preferred embodiments of the fluid dispenser of the invention rotated 90 degree from the up-right position.

FIG. 6 is a cross sectional view B-B of FIG. 4 and FIG. 5.

FIG. 7 is a perspective view of the third preferred embodiments of the fluid dispenser of the invention rotated 90 degree from the up-right position.

FIG. 8 is a cross sectional view C-C of FIG. 7.

### DESCRIPTION OF THE PREFERRED EMBODIMENTS

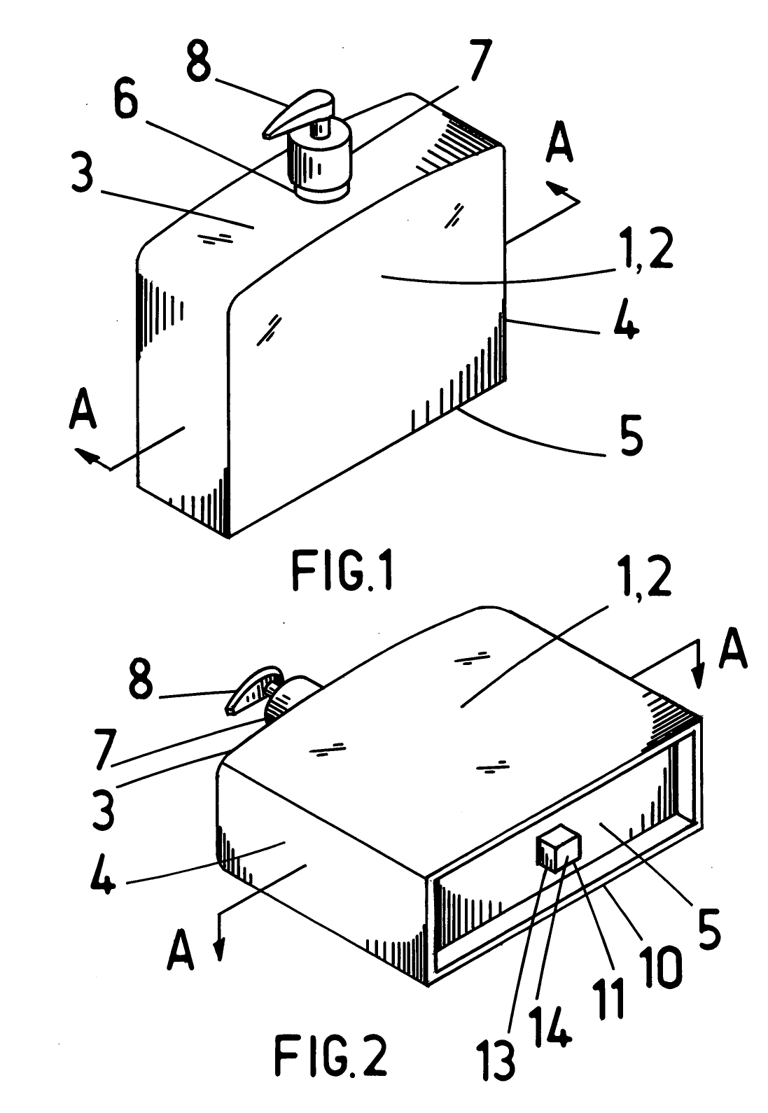

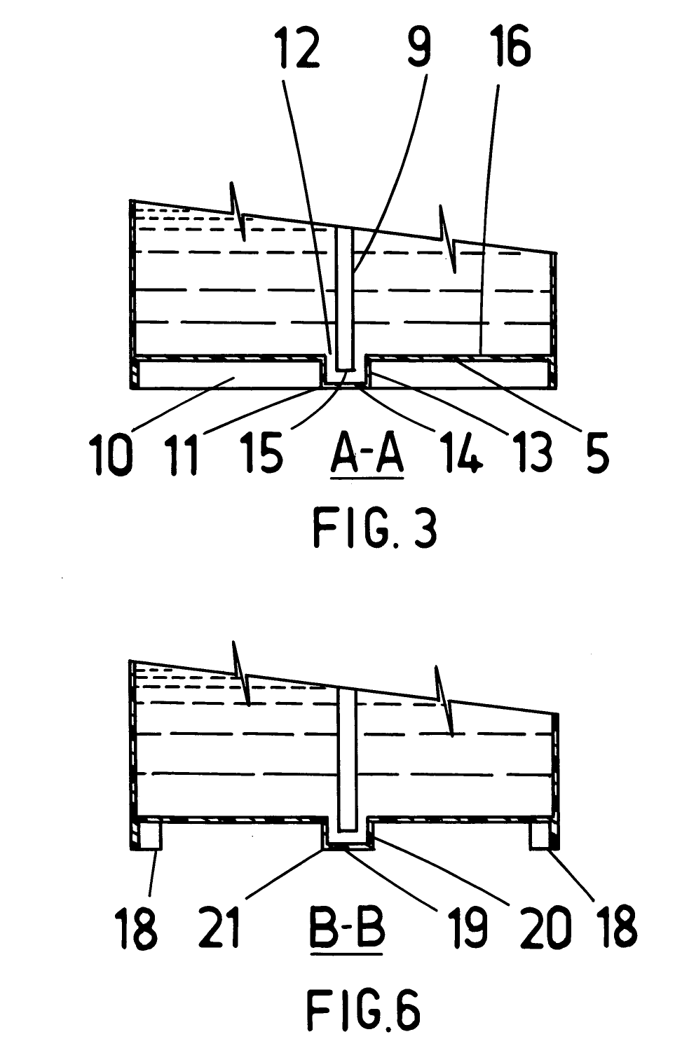

FIG. 1 through FIG. 3 represent the first preferred embodiments of the fluid dispenser of the invention. The fluid dispenser 1 has a main hollow body 2 comprising of a top wall 3, a vertical, circumferential side wall 4, a bottom wall 5, a neck 6 integrally integrated at the top of hollow body 2. A pump actuator 7 and a discharge spout 8 is mounted to neck 6 at the top of hollow body 2. A down comer tube 9 (shown in FIG. 3) is vertically extended from pump actuator 7 to draw the fluid content. A circumferential projectile 10 is extended downward from the circumferential side wall 4, which serves as a circumferential support leg to stably support dispenser 1 in up-right position. The circumferential projectile 10 raises the bottom wall 5 to a height so that a second hollow body 11 can be integrally connected to the bottom wall 5 through an opening 12 (shown in FIG. 3) in the bottom wall 5. The center of hollow body 11 is located substantially in line with the center of neck 6 and down comer tube 9. The main hollow body 2 and the second hollow body 11 form a continuous pressure boundary of fluid content within dispenser 1. The second hollow body 11 has a circumferential side wall 13 and a bottom wall 14. The height of side wall 13 is equal to or marginally less than the height of projectile 10 so that fluid dispenser 1 stably stands in up-right position on projectile 10, and optionally on second hollow body 11. The bottom end 15 of down comer tube 9 is positioned within second hollow body 11 at a level below opening 12, as well as below the interior surface 16 of bottom wall 5. The overall size of second hollow body 11 is substantially small, as long as it provides sufficient clearance around the bottom end 15 of down comer tube 9. Such clearance ensures a smooth flow path of fluid content to be drawn into down comer tube. In this respect, side wall 13 can be vertical, or optionally sloped toward the center of hollow body 11. Also in this respect, the bottom end 15 of down comer tube 9 can be flat, or optionally slanted (say 45 degree). Since the bottom end 15 of down comer tube 9 is below the interior surface 16 of bottom wall 5, the bottom end 15 of down comer tube 9 remains submerged (by fluid content within hollow body 11) even though the fluid content in main hollow body 2 has been completely depleted. As a result, pump actuator 7 is capable of emptying fluid content within hollow body 2 completely. Pump actuator 7 ceases to draw fluid content when the bottom end 15 of down comer tube 9 is uncovered. The wasted residual fluid content is reduced to about the interior volume of second hollow body 11, which is substantially small.

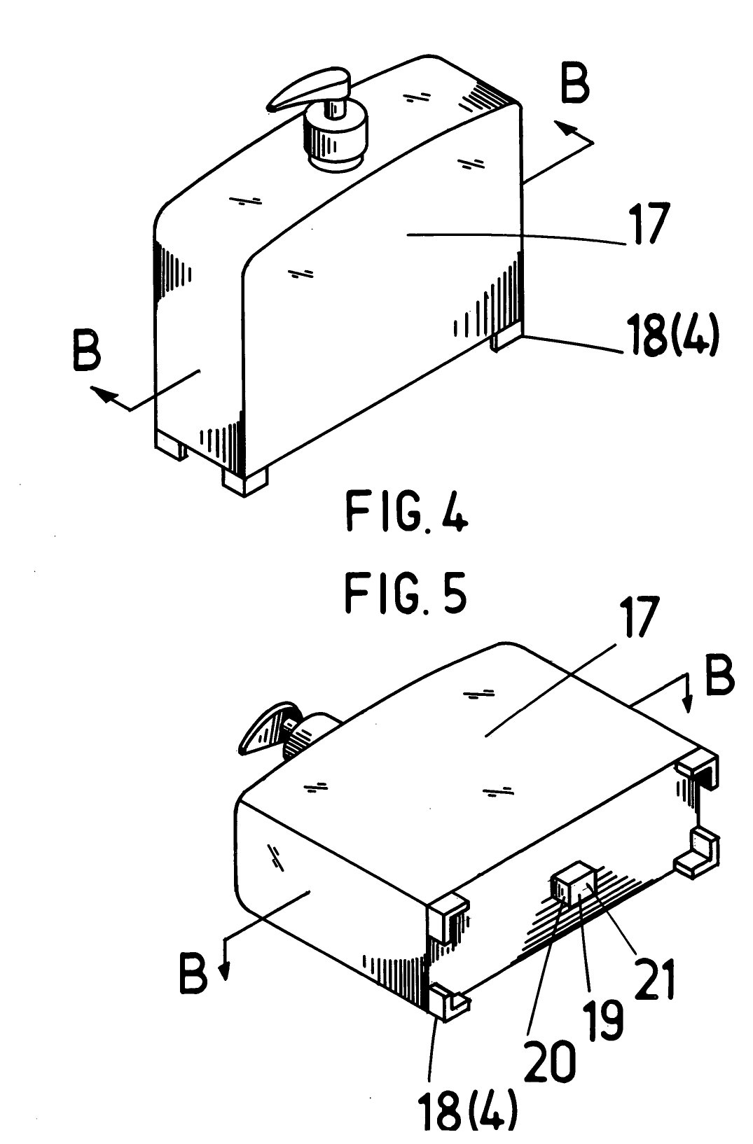

FIG. 4 through FIG. 6 represent the second preferred embodiments of the fluid dispenser 17 of the invention. The fluid dispenser 17 is identical to the fluid dispenser 1 of the first preferred embodiments, with an exception that fluid dispenser 17 is supported by four individual support legs 18 integrally connected to bottom wall 19, and positioned circumferentially around the bottom wall of dispenser 17. It is understood that the height of the side wall 20 of the second hollow body 21 in the second preferred embodiments is equal to or slightly less that the height of legs 18. As a result, dispenser 17 stably stands in up-right position on legs 18, and optionally on hollow body 21.

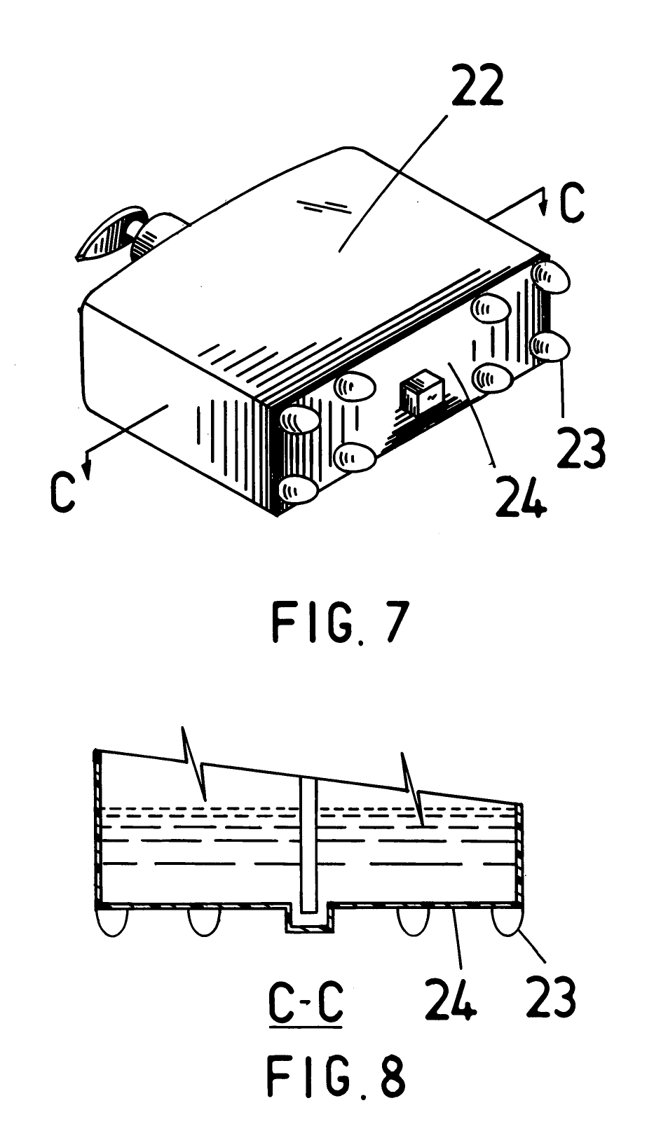

FIG. 7 and FIG. 8 represent the third preferred embodiments of the fluid dispenser 22 of the invention. The fluid dispenser 22 is identical to the fluid dispenser 1 of the first preferred embodiments, or fluid dispenser 17 of the second preferred embodiments, with an exception that fluid dispenser 22 is supported by a plurality of individual support legs 23 integrally connected to bottom wall 24, and positioned throughout the entire coverage area of bottom wall 24.

The main hollow body and second hollow body in the fluid dispensers of present invention are shown in a substantially rectangular shape in the above preferred embodiments. It is considered within the spirit and scope of present invention if a round, square or other shape or configuration of the main hollow body or second hollow body is adopted. It is also considered with the spirit and scope of present invention that support legs of fluid dispenser can be in a shape or configuration different from that of the preferred embodiments. Preferably, the fluid dispensers of present invention in accordance with the above preferred embodiments are made from plastic molding.

What is claimed is:

1. A fluid dispenser comprising of:
A first hollow body, a neck integrated to the top of said first hollow body for filling said first hollow body with a fluid content, a second hollow body integrated to the bottom of said first hollow body, a plurality of support legs, a pumping device and a discharge spout mounted to said neck, and a down comer tube fixedly connected to said pumping device; and
Said first hollow body having a vertical and circumferential first side wall, a first bottom wall and a top wall, wherein, said first bottom wall being integrally connected to a lower end of said first side wall, an inner circumferential end of said top wall being integrally connected to a lower end of said neck, an outer circumferential end of said top wall being integrally connected to an upper end of said first side wall; and
Said second hollow body having a circumferential second side wall and a second bottom wall, wherein, said second bottom wall being integrally connected to a lower end of said second side wall, an upper end of said second side wall being integrally connected to said first bottom wall of said first hollow body through an opening in said first bottom wall, said first and second hollow bodies forming a continuous pressure boundary of said fluid content, and said second hollow body having a substantially smaller interior volume than that of said first hollow body; and
Said support legs being integrally connected to a bottom exterior surface of said first bottom wall of said first hollow body, and said support legs having a height no less than that of said second side wall of said second hollow body so that said dispenser being capable of stably standing in an up-right position on said support legs; and
Said down comer tube being vertically extended downward from said pumping device into the interior volume of said second hollow body through said opening of said first bottom wall of said first hollow body, said down comer tube having a bottom entrance positioned substantially in the center of said second hollow body at an elevation slightly below an interior surface of said first bottom wall of said first hollow body, said interior volume of said second hollow body providing sufficient clearance around said bottom entrance of said down comer tube that enabling said pumping device to draw said fluid content at a full capacity, said pumping device capable of emptying said fluid content within said first hollow body completely so that the volume of residual fluid content remained in said fluid dispenser being reduced to said interior volume of said second hollow body.

2. The fluid dispenser according to claim 1, in which, said bottom entrance of said down comer tube has a horizontal plan.

3. The fluid dispenser according to claim 1, in which, said bottom entrance of said down comer tube has a slanted plan.

4. The fluid dispenser according to claim 1, in which, said second hollow body has said second side wall positioned in a vertical plan.

5. The fluid dispenser according to claim 1, in which, said second hollow body has said second side wall positioned in an incline plan with a downward slope toward the center of said second hollow body.

6. The fluid dispenser according to claim 1, in which, said support legs are in the form of a continuous vertical side wall positioned circumferentially around said first bottom wall of said first hollow body.

7. The fluid dispenser according to claim 1, in which, said support legs are in the form of individual legs positioned circumferentially around said first bottom wall of said first hollow body.

8. The fluid dispenser according to claim 1, in which, said support legs are in the form of individual legs positioned uniformly within the coverage area of said first bottom wall of said first hollow body.
